(19) United States
(12) Patent Application Publication
(10) Pub. No.: US 2002/0115459 A1
(43) Pub. Date: Aug. 22, 2002

(54) Power control for wireless packet packet with application to EDGE system

(76) Inventors: Justin Che-l Chuang, Holmdel, NJ (US); Kin K. Leung, Edison, NJ (US); Xiaoxin Qiu, Bridgewater, NJ (US); Li-Chun Wang, Taipei (TW); Shailehnder Timiri, Bellevue, WA (US)

Correspondence Address: BANNER & WITCOFF, 1001 G STREET N W, SUITE 1100, WASHINGTON, DC, 20001, US

(21) Appl. No.: 09/789,572

(22) Filed: Feb. 22, 2001

(51) Int. Cl. H04B 7/00

(52) U.S. Cl. 455/522; 455/67.1

(57) ABSTRACT

A Kalman-filter power control method is applied to a packet voice service in a wireless network based on interference tracking and predictions. An Enhanced Data for GSM Evolution (EDGE) system is used as an illustrative platform for the invention. The power-control method significantly improves the spectral efficiency by enabling the 1/3 frequency reuse while maintaining a stringent requirement of 2% packet loss probability for voice service. For allocated spectrum of 1.8, 3.6 and 5.4 MHz, the 1/3 reuse with the Kalman power control can yield 102.5%, 49.5% and 32.5% improvement in spectral efficiency over the 3/9 reuse, respectively.

### BACKGROUND OF THE INVENTION

The present invention is generally related to the field of telecommunications and more specifically, is directed to a method of applying a Kalman-filter power control method based on interference tracking and predictions to packet voice services in wireless networks.

The European Telecommunications Standards Institute (ETSI) is in the process of establishing the protocol standards for the Enhanced Data for GSM Evolution (EDGE) system. The EDGE system is another step in the evolution of data communications within existing time division-multiple-access (TDMA) wireless networks. Using packet-switching technology and the existing 200 kHz GSM channels, the EDGE system employs a link-adaptation technique to support data rates approaching 480 kbits/sec. Due to the advantages and flexibility of packet switching, the EDGE system is expected to serve as a platform for integrated services including at least packet voice and data. For voice service, each call alternates between talk-spurts and silence periods. To increase network capacity, radio resources are assigned to a call only when it has packets to transmit during talk-spurt periods. This technique is also known as statistical multiplexing.

Dynamic transmission power control has been widely studied and practiced to combat and manage interference in cellular radio networks. Particularly for TDMA wireless networks like the EDGE system, power control has been shown to be useful in improving network performance and capacity. Existing power control algorithms can be classified as signal-based and signal-to-interference-ratio (SIR) based power control. Signal-based control systems adjust transmission power based on the received signal strength, while the SIR-based power control system changes power according to the ratio of signal and co-channel interference (possibly plus noise) power levels. It is known that SIR-based power control systems yield higher performance gain than the signal-based control systems, although the former is more complicated in implementation due to its required frequent exchange of control information between a receiver to its transmitter.

Mathematically, SIR-based power control can be represented as an iterative algorithm that repeatedly adjusts transmission power according to previous SIR measurements. Due to the nature of iterations, SIR-based algorithms typically perform well for calls with relatively long holding times. For application in wireless packet networks with bursty transmission, a power-control method has recently been proposed that is based on measurements and predictions of interference power by use of a Kalman filter. This work is described by K. K. Leung, “A Kalman-Filter Method for Power Control in Broadband Wireless Networks,” Proc. of IEEE INFOCOM '99, New York, N.Y., March 1999, pp. 948-956. The results reveal the potential performance gain of power control by the tracking of interference power.

Applicants have discovered a novel and unobvious method of applying and quantifying the performance gain of the Kalman power control for packet voice services in the EDGE system. Moreover, Applicants have also discovered that the methods of the present invention may also be used in other wireless packet networks.

### SUMMARY OF THE PRESENT INVENTION

Accordingly, it is the overall objective of the present invention to apply a Kalman power control to packet voice services in wireless networks.

It is a further objective of the present invention to apply a Kalman power control to packet voice services in wireless networks using an Enhanced Data for GSM Evolution (EDGE) system.

It is another objective of the present invention to apply a Kalman power control to packet voice services in wireless networks which can be implemented easily and without burden to users of the network.

It is a still further objective of the present invention to apply a Kalman power control to packet voice services in wireless networks which is economical to implement and simple in operation.

It is another objective of the present invention to apply a Kalman power control to packet voice services in wireless networks which can be readily implemented without undue reconstruction of the existing networks.

It is another objective of the present invention to apply a Kalman power control to packet voice services in wireless networks which can be implemented using existing communication networks.

It is a still further objective of the present invention to apply a Kalman power control to packet voice services in wireless networks based on interference tracking and predictions.

### BRIEF DESCRIPTION OF THE DRAWINGS

The novel features of the present invention are set out with particularity in the appended claims, but the invention will be understood more fully and clearly from the following detailed description of the invention as set forth in the accompanying drawings in which:

FIG. 1 is a flow chart representation of control messages in a downlink transmission in accordance with the present invention;

FIG. 2 is a flow chart representation of control messages in an uplink transmission in accordance with the present invention;

FIG. 3 is graph plotting Erlang/Cell/MHz versus allocated spectrum in MHz in accordance with the present invention;

FIG. 4 is graph plotting cell coverage versus power update period in accordance with the present invention;

FIG. 5 is graph plotting capacity gain versus power update period in accordance with the present invention; and

FIG. 6 illustrates a table of measured SINR and packet error probability in accordance with the present invention.

### DESCRIPTION OF THE PREFERRED EMBODIMENT

The EDGE system will now be described in more detail with reference to the present invention. Application of the present invention to the EDGE system is by way of example only and is not intended to limit the present invention to such system.

The EDGE system makes use of existing 200 kHz channels (carriers) in the GSM. Each carrier is divided into time slots and 8 adjacent slots form a TDMA frame, which lasts for 4.615 msec. As currently proposed, the EDGE system has nine modulation and coding schemes (MCS's) and uses a link-adaptation technique to adapt packet transmission to one of the schemes according to the link quality. It is assumed that packets of all calls are transmitted at MCS-2 (using GMSK modulation) to achieve robustness and a data rate of 11.2 kbits/sec per time slot which is adequate for voice applications.

Typically, a device that synthesizes speech, i.e., a vocoder, generates one voice packet (also known as voice frame) per 20 msec. Each voice packet is treated as a radio-linkcontrol (RLC) block. In turn, each RLC block is divided into four bursts, which are transmitted in a designated time slot over four successive TDMA frames, one burst per frame. For simplicity, these four time slots (or TDMA frames) for carrying the four bursts of voice packet can be treated as a single time slot (or TDMA frame).

For packet voice service, each call alternates between a talking mode, at which voice packets are generated periodically by the vocoder, and a silence period for both downlink and uplink transmission. When a mobile station (MS) starts a talk spurt for uplink transmission, it first sends a signaling message to its base station (BS) to request a quick assignment of a voice channel (i.e., a time slot on a particular frequency carrier) to carry the newly generated voice packets. The BS chooses one available channel for the request and instructs, via a downlink control channel, the MS to start transmission in that time slot. At the end of the talk spurt, the latter channel is relinquished for use by other calls. Similarly, when a talk spurt is started for downlink transmission, the BS sends a paging message over a control channel to the MS and instructs the latter to receive its packets on a particular voice channel. Upon receiving an acknowledgment from the MS via a control channel, the BS starts packet transmission in the chosen channel. Again, the channel is released upon the completion of the talk spurt.

The response times of existing GSM protocols are too long for supporting fast resource assignment on a per talk-spurt basis. For this reason, a set of new signaling protocols has been proposed to maintain satisfactory voice clipping (i.e., loss of first few packets of a talk spurt). See X. Qiu, K. Chawla, L. F. Chang, J. C.-I. Chuang, N. R. Sollenberg and J. Whitehead, “RLC/MAC Design Alternatives for Supporting Integrated Services over EGPRS,” IEEE Personal Communications, 2000.

In accordance with the present invention, the Kalman-filter method is used to control transmission power. For each MS with power on, it continuously measures the interference-plus-noise power (referred to hereafter as “interference power”) for a small set of downlink voice channels, which is being used or may be used to carry future voice traffic from the BS to the MS. These measurements are continuously fed into a Kalman filter to predict future interference power on these channels. Similar processes are also performed at each BS to track interference power for the uplink transmission, Since voice packets of a talk spurt associated with each call are transmitted in the same time slot over successive TDMA frames (i.e., a voice channel) in the EDGE system, we need only focus on that time slot and index the TDMA frames by n. For a transmitter, either a MS or BS, its transmission power in the time slot of frame n is set to be

p(n)=γ*Ĩ(n)/g(n) (1)

Where γ* is the SINR target for the voice service using the MCS-2, Ĩ(n) is the interference power (in mW) for the slot in frame n predicted by the Kalman filter, and g(n) is the path gain between the transmitter and the intended receiver in frame n. By use of a control channel associated with each call (particularly for handoff purposes), the path gain g(n) can be estimated and known to both the MS and its BS in the EDGE system.

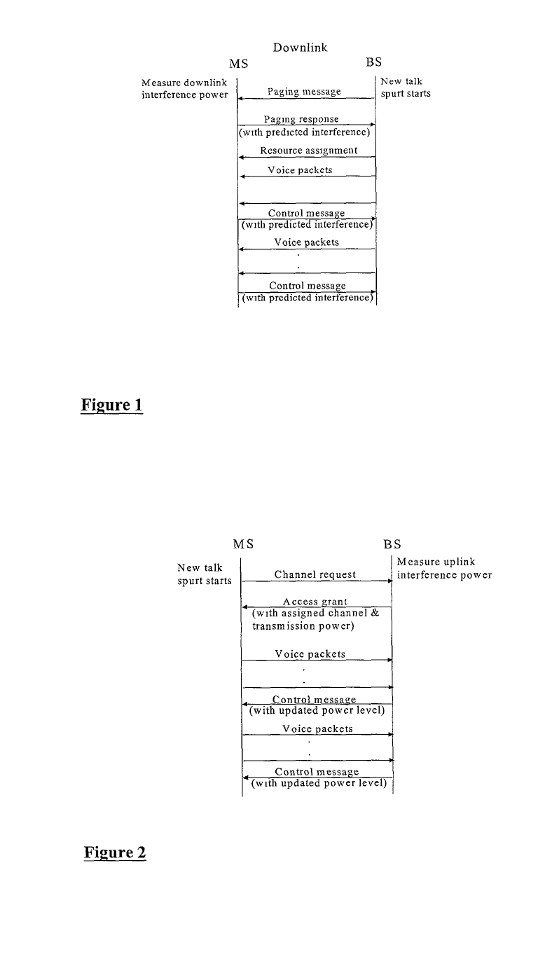

The Kalman method represents a closed-loop control that requires exchange of control information between the receiver and the transmitter. Such exchange of information can be made possible by including the pertinent information in appropriate control messages. One such scenario of message exchanges is illustrated in FIGS. 1 and 2.

As shown in FIG. 1, when an established call is in a silent period for downlink transmission, the associated MS continuously measures and predicts by use of the Kalman filter the interference power on several channels which may be used to transmit the next talk spurt on the downlink. When the next talk spurt starts, the BS sends a paging message to the MS over a control channel. In turn, the MS includes the predicted interference power for a few voice channels in the paging response message. The BS selects (possibly making use of the interference predictions) and informs the MS of the chosen channel in the resource-assignment message. Then, the BS can start transmitting voice packets. While receiving packets, the MS continues to measure and predict interference power for the given set of channels, including the channel where packets are received. Periodically, it sends the interference prediction for the receiving channel back to the BS via a control channel. With the new prediction Ĩ(n), the BS adjusts its transmission power according to Equation 1 expressed above. Similar operations apply to the uplink transmission as illustrated in FIG. 2.

A computer simulation can be used to quantify the performance of Kalman power control for packet voice service. A total of 37 cells in a traditional hexagonal layout is simulated. Each cell is divided into three sectors, each of which is served by a BS antenna at the center of the cell. The 3-dB beamwidth of each BS antenna is 60 degrees while MS's have omni-directional antenna. The BS antenna has a front-to-back gain ratio of 25 dB. Frequency reuse factors of 1/3 and 3/9 are considered in the simulation. Each radio link between an MS and a BS is characterized by a path-loss model with an exponent of 3.5 and lognormal shadow fading with a standard deviation of 6 dB. Cell radius is assumed to be 1 Km and the path loss at 100 m from the cell center is −73 dB and thermal noise at each receiver is fixed and equal to −116 dBm (for the 200 kHz GSM channel with 5 dB noise factor). Transmission power is limited between 1 to 30 dBm. Each sector is populated with 100 MS's randomly and each of them selects the BS that provides the strongest signal power. The results reported below are aggregated from six independent runs, each of them lasted for a fraction to one million time slots. All MS's remain at the fixed locations throughout the simulation. In the interest of simplicity, it is assumed that timing for all co-channel sectors are synchronized at the slot boundary for transmission.

The MCS-2 is used for transmitting voice packets. For each packet transmission, the SINR is measured at the receiving end, which in turns depends on the path loss, shadowing and interference power. The SINR measurement is rounded to its closest integer value in dB and the packet error is determined based on the SINR value and the corresponding error probability (which are averaged over Rayleigh fading with cyclic-frequency hopping) in the table illustrated in FIG. 6. Packet error probability is zero if the SINR exceeds 23 dB. With these error results, the SINR target γ* for power control in Equation 1 is selected by repeated test runs so that the chosen target minimizes the overall packet error rate. Using this approach, it was found that γ*=15 dB provides the best results.

The durations of a talk spurt and silent period for each call are exponentially distributed with an average of 1 and 1.35 sec, respectively. As a packet is generated every 20 msec, the number of packets in a talk spurt is geometrically distributed with an average of 50. When a talk spurt starts, the BS randomly assigns one of its available channels to carry the talk spurt. If no channel is available, the entire talk spurt is assumed to be lost (or blocked).

Since each sector typically has tens of voice channels and since each of the MS's and BS's in the system needs to measure and track interference power continuously, the simulation model requires a great deal of CPU time. To make the model efficient, simulation of interference measurement and tracking is limited to only one voice channel in all co-channel sectors. For example, consider a downlink transmission where a talk spurt is sent to an MS in a sector over the channel. Following that, the channel remains idle in the sector for a random duration of time, which is geometrically distributed with a mean matching a given traffic load. After the idle period, the BS starts a transmission of a new talk spurt for another randomly selected MS in the sector. The packet error statistics are collected for each MS over the entire simulation run. This simplified approach essentially yields the same results as if the details of multiple channels and the random channel assignment scheme are simulated.

The quality of packet voice service can be said to be satisfactory if (a) the blocking probability of both the new call and talk spurt due to channel unavailability is less than 2%, and (b) packet error rate does not exceed 2% for calls associated with at least 90% of MS's in each sector (i.e., a 90% coverage requirement). By assuming that talk spurts arrive according to a Poisson process, the voice capacity is the maximum traffic load in Erlang while maintaining satisfactory service quality.

As a comparison, in addition to the Kalman power control Applicants also studied the voice performance of the traditional SIR power control as described by G. J. Foschini and Z. Miljanic, “A Simple Distributed Autonomous Power Control Algorithm And Its Convergence,” IEEE Trans. On Veh. Tech. Vol. 42, No. 4, November 1993, pp. 641-646. Specifically, the transmission power of the first packet of a talk spurt is chosen to fully compensate its path loss and shadow fading. Power for the subsequent packets (indexed by n) are adjusted according to

p(n)=p(n−1)γ*/β)(n−1) (2)

Where β(n−1) and γ* are the measured SINR for packet n−1 and the target SINR, respectively. Note that exponential smoothing can be applied to the SINR measurements in the method proposed in by G. J. Foschini et al. cited above. Since the measurements are assumed to be error free, the smoothing is not included in Equation 2 to improve the speed of convergence.

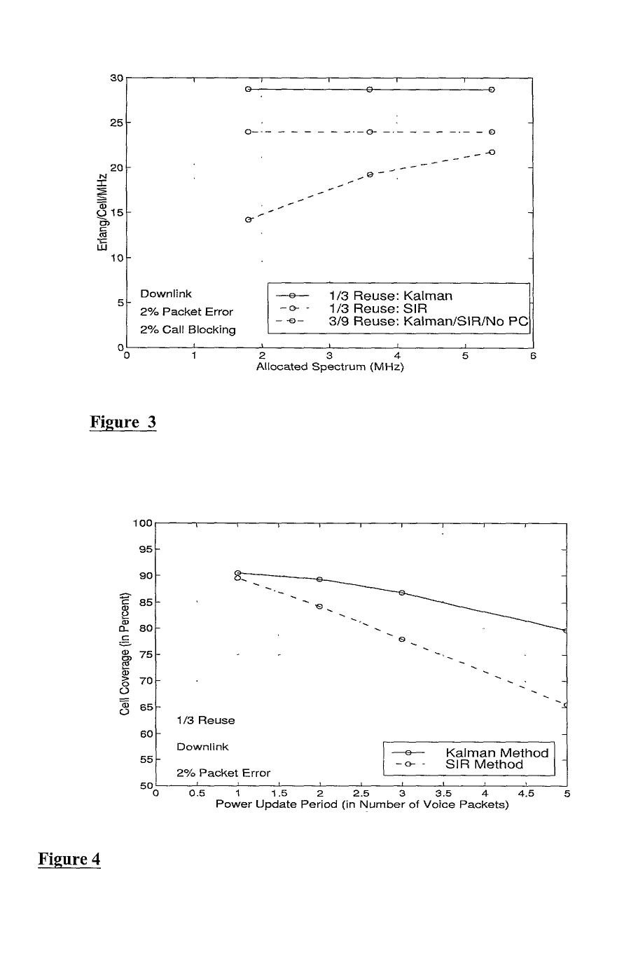

In FIG. 3, the voice service is allocated with 1.8, 3.6 and 5.4 MHz spectrum. Correspondingly, for the 1/3 reuse, each sector is assigned with 24 (i.e., 3 carriers times 8 slots), 48 and 72 voice channels, respectively. Similarly, for the 3/9 reuse, each sector has one third of these many channels. FIG. 3 shows the downlink spectral efficiency in terms of Erlang/cell/MHz for the voice service with the Kalman, SIR and no power control. The results in FIG. 3 assume that the SINR and interference power can be measured accurately, the measurements for one voice packet can be used to control transmission power for the next packet (i.e., the measurement and control feedback delay is assumed to be less than 20 msec).

Several observations can be made from the above described studies. First, the results for the 3/9 reuse show that the Kalman and SIR power control enable each voice channel to carry 100% of traffic load, and no power control can support 70% traffic while meeting the required 2% packet loss probability for 90% of MS's in each sector. However, the limiting factor for the spectral efficiency of the 3/9 reuse is the blocking probability for talk spurts. As a result, the Kalman, SIR and no power control yield the same spectral efficiency, as shown in FIG. 3. As the allocated spectrum increases, the trunking efficiency and thus the spectral efficiency are improved. On the other hand, since the 1/3 reuse is the lowest reuse factor, each sector is allocated with the maximum possible number of channels for a given spectrum allocation, thus avoiding the trunking inefficiency. The limiting factor for the voice capacity in the 1/3 reuse is the packet loss probability which is mainly determined by the carried traffic load of each channel and thus the interference. In this case, since the voice capacity is almost directly proportional to the maximum feasible load on each channel (as traffic load is balanced among all channels by the random channel assignment), the spectral efficiency becomes independent of the actual spectrum allocation as shown in FIG. 3.

A second observation that can be made from the above described studies is that the simulation results reveal that the Kalman and SIR power control support each channel to carry a maximum of 30% and 25% of traffic load, respectively, to maintain the stringent 2% loss probability with 90% coverage. For the 1/3 reuse, the spectral efficiency for the power control methods is 28.78 and 23.98 Erlang/cell/MHz, respectively. That is, the Kalman power control yields about 20% improvement on spectral efficiency when compared with the SIR control, as shown in FIG. 3. Furthermore, for the 1.8, 3.6 and 5.4 MHz spectrum allocation, the 1/3 reuse with the Kalman power control provides 102.5%, 49.5% and 32.5% improvement in spectral efficiency, respectively, over the 3/9 reuse with the Kalman, SIR or no power control. Although it is not illustrated in FIG. 3, the maximum feasible load on each channel for the 2% loss probability is only 5% when no power control is used (i.e., each transmitter transmits at a fixed power of 30 dBm). The spectral efficiency for no power control is one-sixth of that for the Kalman method in FIG. 3. Consequently, the spectral efficiency for the 1/3 reuse without power control is so low that it is much better off to use the 3/9 reuse if no power control is used. This is so because without power control, the 3/9 reuse simply provides better interference protection than the 1/3 reuse.

Besides the 20% improvement of the Kalman power control over the SIR control in FIG. 3, the above described results also reveal that the former method is more robust than the latter in terms of coverage. More specifically, FIG. 4 shows the impact of coverage due to power update periods for both power control methods. To obtain these results, MS's continue to measure and track interference power for each packet transmission, but the transmission power is updated periodically according to the given update period. As mentioned earlier, the 90% coverage requirement is met by the methods when the system runs at their respective capacity of 30% and 25% traffic load. However, at their capacity load, if transmission power is updated every two voice packets, the coverage for the Kalman and SIR method reduces to 89.3% and 84.3%, respectively. As shown in FIG. 4, additional increase in the power update period further degrades the coverage performance. Nevertheless, these results show that the Kalman power control is more robust than the SIR as far as power update period is concerned.

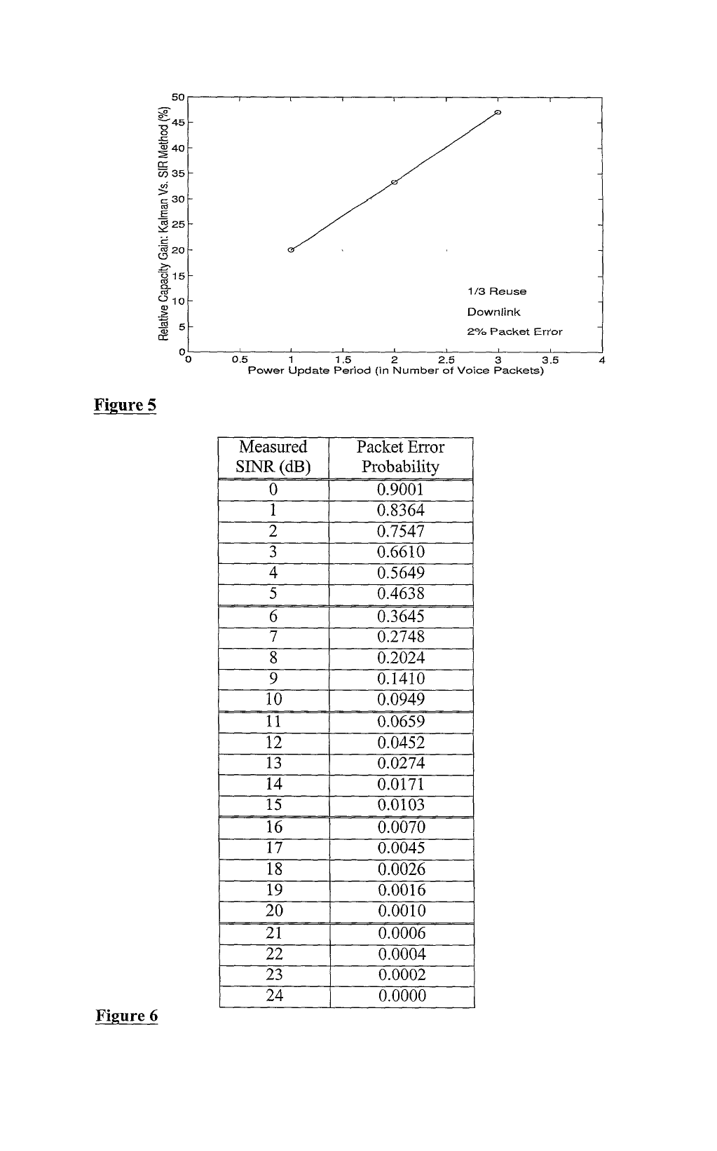

The reduction in cell coverage due to an increase in power update period actually translates into a decrease in voice capacity, if the 90% coverage has to be maintained. FIG. 5 shows the relative capacity gain of the Kalman method over the SIR method for various power update periods. Specifically, the relative gain for the Kalman power control increases from 20% to 47% when the frequency of updating transmission power is decreased from once every one packet to once every three packets. This significant improvement may probably justify the additional overhead in protocol and interference tracking of the Kalman method.

The Kalman power control method performs better than the SIR method as shown in FIGS. 3 to 5. In actuality, the two methods are similar. To see that, using a fact that β(n−1)=p(n−1)g(n−1)/I(n−1) where I(n−1) is the actual interference power for packet n−1, Equation 2 above becomes

p(n)=γ*I(n−1)/g(n−1). (3)

If the path gain g(n) does not change drastically from one packet to the next, Equations 1 and 3 are similar, except that the Kalman method in Equation 1 is based on interference prediction Ĩ(n), while the SIR method uses the actual interference power for the last packet. In essence, the Kalman method provides some sort of smoothing on the interference measurements. If the measurements contain errors, this smoothing effect can lead to performance improvements when compared with the SIR method. Of course, similar smoothing can also be applied to the SIR method for performance improvement. Nevertheless, in case of accurate measurements and the path gains remain unchanged over time as assumed here, the smoothing effect will not provide a significant difference in performance.

On the other hand, for the settings considered here, the major difference between the Kalman and SIR method lie in the ways they choose the transmission power for the first packet of each talk spurt. For traditional circuit-switched voice service, the selection of the first transmission power has little impact on the overall network performance because call holding time is much longer than the power update period to ensure the “convergence” of the appropriate transmission power. However, for packet voice service with an average of 50 packets per talk spurt, the selection of the first transmission power becomes important. Since the Kalman method continuously tracks and predicts interference power, the transmission power can be appropriately selected for the first packet according to Equation 1. In contrast, the SIR method chooses the first power to fully compensate the signal path gain, which can be quite different from the appropriate power level to combat interference. For this reason, the SIR method does not perform as well as the Kalman method does for packet voice service.

The exchange of control messages for the Kalman power control has been outlined in FIGS. 1 and 2. These messages relate to the EDGE protocols in the following way. For downlink transmission of a talk spurt, the paging message and the paging response in FIG. 1 are sent on the packet paging channel (PPCH) and the packet random access channel (PRACH), respectively. The current protocol specifications do not include the interference prediction information in the paging response message. So, the proposed Kalman method will require several bit positions (e.g., Applicants have found that 4 to 5 bits are typically sufficient to cover a dynamic range of 30 dB) for each channel under tracking in the message. The resource-assignment message and voice packets in FIG. 1 are transmitted over the packet access grant channel (PAGCH) and packet data traffic channel (PDTCH), as specified in the current protocols. On the other hand, the existing specifications cannot adequately support the transmission of fast, periodic control message with updated interference prediction for the voice channel in use. One could transmit the control messages on the packet associated control channel (PACC), but its frequency is not high enough for the fast power control method. For example, the results in FIG. 4 show that if the power update period is longer than three packets (i.e., 60 msec), the performance gain of power control degrades quickly. The Kalman power control requires fast and frequent transfer of updated interference predictions from the receiving MS to its BS.

For uplink transmission of voice packets, the channel request and access grant message (with the assigned channel and transmission power information) in FIG. 2 can be sent via the fast packet random access channel (F-PRACH) and the fast packet access grant channel (F-PAGCH) proposed in the Qiu paper cited above. Similar to the downlink transmission, current protocols do not support fast and frequent transfer of updated transmission power from the BS to the receiving MS. One possible way is to attach the power information to the uplink state flag (USF), so that an MS knows in which time slot (by the function of USF) and at what power level it can transmit a voice packet. However, this approach represents an interim approach because the USF is embedded at the beginning of each downlink RLC block. Since the intended receiving MS's of the USF and the data block are likely to be different and can be located far apart, the approach of augmenting power information to the USF will not work well, for example, when smart antennas are employed to target a transmission to its intended receiver with reduced beamwidth for capacity improvement. An ideal, long-term solution would be to establish a fast control channel for frequent transfer of power-control information from BS to MS.

The Kalman power control requires both BS's and MS's to continuously measure and track interference power received from co-channel sectors. In practice, MS's can probably monitor interference power for a small number of traffic channels (e.g., a few time slots on the same frequency carrier) to conserve battery power. The interference power is equal to the difference between the total received power and the power of the desired signal, where the latter can be measured by filtering based on the training sequence for the signal. It is a common practice that the same training sequence is used for transmission to any MS on a given voice channel. Since the sequence is made known to all MS's currently receiving packets or tracking interference on the channel, they can apply various techniques such as known in the art to measure the interference (plus noise) power.

In accordance with the present invention and using the EDGE system as an example, Applicants have applied the Kalman-filter power control method based on interference tracking and prediction to packet voice service. The results reveal that the power-control method significantly improves the spectral efficiency by enabling the 1/3 frequency reuse while maintaining the stringent 2% packet loss probability and 90% coverage for voice service, thus avoiding the “trunking inefficiency” of high reuse factors. More specifically, for allocated spectrum of 1.8, 3.6 and 5.4 MHz, the 1/3 reuse with the Kalman power control can yield 102.5%, 49.5% and 32.5% improvement in spectral efficiency over the 3/9 reuse, respectively. Applicants have also found that the Kalman method provides 20% additional spectral efficiency when compared with a traditional SIR power control method. In addition, the former method is more robust than the latter for increased power update period.

It should be obvious from the above-discussed apparatus embodiment that numerous other variations and modifications of the apparatus of this invention are possible, and such will readily occur to those skilled in the art. Accordingly, the scope of this invention is not to be limited to the embodiment disclosed, but is to include any such embodiments as may be encompassed within the scope of the claims appended hereto.

We claim:

1. A method of applying a Kalman filter power control to a packet voice service in a wireless network having a plurality of communication channels, a receive and a transmitter, said method comprising the steps of:
continuously measuring and predicting the interference power on at least one of said communication channels to provide a power control signal; and
using said power control signal to adjust the transmission power of said transmitter.
